(19) United States
(12) Patent Application Publication
(10) Pub. No.: US 2005/0211702 A1
(43) Pub. Date: Sep. 29, 2005

(54) Crucibles for a microwave sintering furnace

(75) Inventors: Paul Gigl, Centre Hall, PA (US); Mark C. Hunt, Tomball, TX (US)

Correspondence Address: MILLEN, WHITE, ZELANO & BRANIGAN, P.C., 2200 CLARENDON BLVD., SUITE 1400, ARLINGTON, VA, 22201, US

(73) Assignee: Dennis Tool Company

(21) Appl. No.: 10/811,623

(22) Filed: Mar. 29, 2004

(51) Int. Cl. H05B 6/78

(52) U.S. Cl. 219/700

(57) ABSTRACT

Incidents of fracturing of crucibles during microwave sintering are reduced through the use of low thermal shock resistance crucibles comprised predominately of an alloy of silicon nitride and aluminum oxide.

### FIELD OF INVENTION

The invention pertains generally to microwave sintering.

### BACKGROUND OF THE INVENTION

Microwave sintering is well known type of sintering process that has several advantages over conventional sintering processes. It is, for example, possible to achieve cemented tungsten carbide parts with small grain sizes in shaped parts that also have high hardness, toughness and density, without the use of grain growth inhibitors. Parts sintered using microwave energy typically exhibit superior physical properties as compared to the same parts sintered using conventional processes

During microwave sintering, material to be sintered is subjected to microwave energy at frequencies and energy levels that result in heat being generated inside the entire volume of material. The volumetric heating of the material results in fewer thermal gradients and less distortion of in the sintered parts. Heat need not be applied externally, thought it may be applied initially to raise the temperature of the material in order to improve initially absorption of the microwave energy. As the temperature of the material increases above a certain point, dielectric loss begins to increase rapidly and the sintered part begins to absorb microwave energy more efficiently.

In order to obtain the advantages of high temperature microwave sintering techniques, heating rates can be as high as 300° C. per minute, which are considerably higher than heating rates in conventional processes. Process cycles can be 2 to 3 hours rather than 15 to 20 hours using conventional sintering processes. Sintering temperatures are 5 to 10 minutes rather than 3 to 4 hours. Furthermore, microwave sintering typically requires 50 to 100° C. lower temperatures than conventional sintering techniques.

Both batch and continuous processing systems are known. In a batch processing mode, green parts are placed, for example, in boats, trays, dishes or crucibles, which in turn are placed inside a chamber. Once the chamber is closed and evacuated or filled with an appropriate atmosphere for sintering, the chamber is subjected to microwave radiation that heats the parts to sintering temperature. Following sintering, the parts are removed from the chamber. In a continuous sintering mode, parts are transported through microwave radiation in a rapid and more or less continuous fashion. The rapid rate is required to heat the parts quickly and cool the parts quickly. Rapid heating sinters the grains of the parts together with minimal grain growth; quick cooling locks in desired properties. One example of a continuous process system is a microwave “furnace” disclosed in U.S. Pat. No. 6,004,505, which relies on gravity to move vertically stacked crucibles through a microwave applicator.

### SUMMARY OF THE INVENTION

The standard crucible material for conventional sintering at high temperatures is alumina since it is available with adequate physical properties and is relatively inexpensive. One problem that has been observed, particularly when using a continuous microwave sintering process to sinter cemented tungsten carbide materials, is that crucibles made of alumina suffer from a relatively high incidence of fracture during or immediately after sintering. Although broken crucibles are undesirable in any sort of microwave sintering process, they are a substantial problem in a process relying on them to transport parts, especially a process in which crucibles are stacked for transport.

The invention involves a discovery that at least one cause of alumina crucibles breaking during microwave sintering is thermal stress or shock caused by the heating of the parts carried by a crucible followed by rapid cooling of the crucible when the parts are no longer exposed to microwave energy. Although alumina crucibles are relatively transparent to microwave energy, heat from the parts carried by the crucible cause the alumina crucible to rapidly heat through one or more heat transfer mechanisms, including convection, conduction and radiation. Cooling is accomplished from the outside of the crucible by removing the heat as quickly as possible in cooling chambers.

Rapid heating of the parts is essential to the microwave sintering process. Rapid cooling or quenching of the parts is also desirable and is readily accomplished during a contiguous process when small efficient quantities of parts move into the cooling portion of the equipment. Altering the rate of heating and cooling of the parts to reduce thermal shock to the alumina crucible is counter productive and therefore undesirable.

According to the invention, containers that are used to carry parts for rapid microwave sintering, and that may take the form of crucibles, boats, trays, or dishes, for example, are composed predominately of a refractory material or materials. These are relatively transparent to microwave radiation—at least at wavelengths used to sinter the parts to be carried by the crucibles—but possess significantly greater ability to withstand thermal shock than alumina.

### BRIEF DESCRIPTION OF THE DRAWINGS

FIG. 1 is a schematic illustration of a furnace for a continuous microwave sintering process.

### DETAILED DESCRIPTION OF A PREFERRED EMBODIMENT

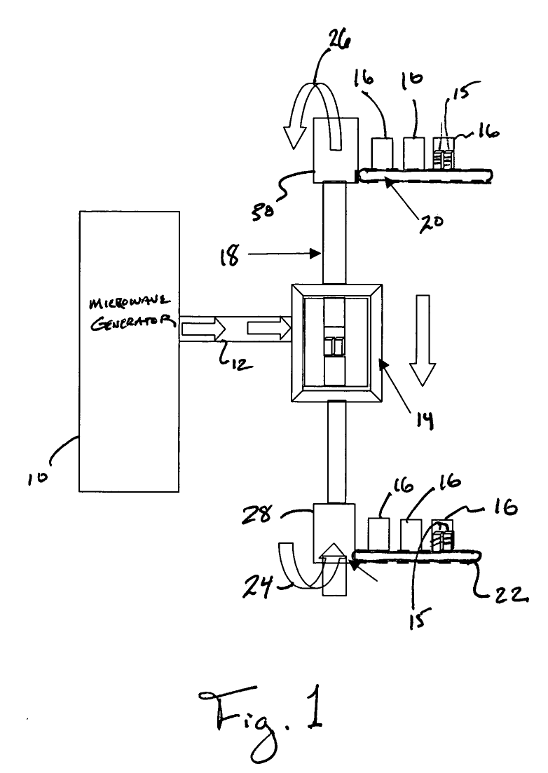

FIG. 1 is an example of a furnace for a continuous microwave sintering process. Electromagnetic waves generated by microwave energy generator 10 are transmitted through waveguide 12 to chamber 14. One or more parts 15 to be sintered—called “green parts”—are placed inside crucibles 16. The green parts are shaped according to well-known processes and placed or stacked in each crucible. The crucibles are then transported through chamber 14, where they are subjected to microwave energy. The crucibles are preferably made from a material that has a very low “coupling” with microwave energy and thus is somewhat “transparent” to the microwaves that are used to heat the material from which the parts are made.

In the illustrated example, gravity is used to transport the crucibles through the microwave by stacking them vertically and moving the stack through chamber 14 by removing the bottom-most crucible one at a time. A vertical tube 18 or other structure may be used to keep the crucibles stacked and provide an enclosed environment for an appropriate atmosphere. Crucibles are conveyed into to an opening at the top of the tube using a conveyer 20 or any other type of transport or conveyance means. The crucibles exit an opening in the bottom of the tube onto conveyor 22. An inert or reducing gas is introduced into the tube near the bottom of the tube and exits the tube near the top of it, as indicated by arrows 24 and 26. A structure 28, which will be referred to as the “ejector box” allows the crucibles to be ejected from the tube while preventing air from entering the tube and gas from spilling out of the tube. A similar structure 30 is located at or near the top end of the tube for allowing crucibles to be inserted into the tube while keeping air out of it. Additional details of this type of continuous process system can be found in U.S. Pat. No. 6,004,505 and related patents.

In order to reduce the risk of fracture due to thermal stress, containers carrying green parts are made predominately from one or more materials that tend not to absorb microwave radiation—at least at wavelengths used to sinter parts to be carried by the crucibles—and that possess significantly greater ability to withstand thermal stress or shock than alumina. One measure of the ability to withstand thermal shock is thermal shock resistance (ΔTK or ΔTC) as described in ASTM Standard Test Method C 1525. It is preferable to use materials with thermal shock resistance greater than 350. Other measures of ability to withstand thermal shock include strength and toughness.

Examples of such materials are silicon nitride, alloys of silicon nitride, including specifically an alloy composed of silicon nitride and aluminum oxide called “sialon,” hexagonal boron nitride, and low thermal expansion ceramics like sodium zirconium phosphate (NZP). Other materials that absorb microwave energy relatively efficiently such as graphite, silicon carbide, and zirconia may be useful for limited situations when external heating of the parts is desirable and not excessive. Sialon is thought to have a greater ability to withstand the thermal shock due at least in part to its better thermal conductivity and a structure that is able to better withstand stress. Silicon nitride and sialon also possess high thermal shock resistance due at least in part to their high strength, hardness and fracture toughness, and low thermal expansion. Sialon is preferred for the reason that it is readily available, relatively inexpensive and can be relatively easily formed into requisite shapes, such as crucibles suitable for use with the microwave sintering furnace shown in FIG. 1.

It has been found that using crucibles made of such material or materials in the microwave sintering furnace shown in FIG. 1 significantly reduces the incidence of crucibles fracturing due to thermal shock that results from the heating of the crucibles by the parts and the rapid cooling of the crucible following the exiting of the microwave applicator, i.e. chamber 14.

Furthermore, it has been found that the parts and crucibles heat proximate structures, including for example portions of tube 18 that transports crucibles through chamber 14. It is therefore preferable to have such proximate structures such as tube 18 also made predominately of one or more of the materials having high thermal shock resistance.

1. A microwave sintering furnace comprising,
a source of microwave radiation;
a chamber, coupled to receive the microwave radiation, in which green parts may be sintered by the microwave radiation; and
a container for holding the green parts during sintering within the chamber, the container being comprised predominately of one or more materials each having an ability to withstand thermal shock that is greater than that of alumina.

2. The microwave sintering furnace of claim 1, wherein each of the one or more materials is selected from the group of silicon nitride, alloys of silicon nitride, hexagonal boron nitride and low thermal expansion ceramics.

3. The microwave sintering furnace of claim 1, wherein the one or more materials includes an alloy comprised of silicon nitride and aluminum oxide.

4. The microwave sintering furnace of claim 1, further including a structure for transporting in a substantially continuous fashion the container through the chamber.

5. The microwave sintering furnace of claim 4, wherein the structure is comprised of one or more materials, at least one of which is a material having an ability to withstand thermal shock greater than that of alumina.

6. The microwave sintering furnace of claim 4, wherein the structure is comprised predominately of one or more materials selected from the group of silicon nitride, alloys of silicon nitride, hexagonal boron nitride and low thermal expansion ceramics.

7. The microwave sintering furnace of claim 6, wherein the structure is in the form of a tube, and the container is in the form of a crucible, and wherein there are a plurality of crucibles stacked end to end in the tube.

8. The microwave sintering furnace of claim 7, wherein the tube is comprised of one or more materials, at least one of which is a material having thermal shock resistance greater than that of alumina.

9. The microwave sintering furnace of claim 4, wherein the structure is comprised predominately of an alloy comprised of silicon nitride and aluminum oxide.

10. A method for sintering parts using microwaves, comprising:
placing at least one part to be sintered into a container; and
subjecting the part to microwave radiation;
wherein the container is comprised predominately of one or more materials each having an ability to withstand a thermal shock greater than that of alumina.

11. The method of claim 10, wherein each of the one or more materials is selected from a group consisting essential of silicon nitride, alloys of silicon nitride, hexagonal boron nitride and low thermal expansion ceramics.

12. The method of claim 10, wherein the one or more materials include an alloy comprised of silicon nitride and aluminum oxide.

13. The method of claim 10, further including transporting in a substantially continuous fashion the container through the chamber using a structure that extends through the chamber.

14. The method of claim 13, wherein the structure is comprised predominately of one or more materials, at least one of which is a material having an ability to withstand thermal shock greater than that of alumina.

15. The method of claim 13, wherein the structure is comprised of one or more materials, at least one of which is a material selected from the group of silicon nitride, alloys of silicon nitride, hexagonal boron nitride and low thermal expansion ceramics.

16. A crucible for carrying green parts during microwave sintering comprised of one or more materials each having a thermal shock resistance substantially greater than that of alumina.

17. The crucible of claim 16, wherein each of the one or materials is selected from a group consisting essentially of silicon nitride, alloys of silicon nitride, hexagonal boron nitride and low thermal expansion ceramics.

18. The crucible of claim 16, wherein the one or more materials includes an alloy comprised of silicon nitride and aluminum oxide.

19. A microwave sintering furnace comprised of:
a source of microwave radiation;
a chamber coupled to receive the microwave radiation, for sintering green parts;
an elongated structure extending through the chamber for transporting containers carrying green parts through the chamber in a substantially continuous fashion, the elongated structure being comprised of one or more materials, at least one of which is a material having an ability to withstand thermal shock greater than that of alumina.
